(19) United States
(12) Patent Application Publication
(10) Pub. No.: US 2025/0058380 A1
(43) Pub. Date: Feb. 20, 2025

(54) METHOD FOR MANUFACTURING A MOLDING ELEMENT BY ADDITIVE MANUFACTURING AND CHEMICAL ATTACK

(71) Applicant: COMPAGNIE GENERALE DES ETABLISSEMENTS MICHELIN, Clermont-Ferrand (FR)

(72) Inventors: ROMAIN CALVEL, Clermont-Ferrand (FR); PIERRE CHIGROS, Clermont-Ferrand (FR)

(21) Appl. No.: 18/720,942

(22) PCT Filed: Dec. 15, 2022
(86) PCT No.: PCT/EP2022/086234

§ 371 Date: Jun. 17, 2024

(30) Foreign Application Priority Data
Dec. 17, 2021 (FR) FR2113863

(51) Int. Cl. B22F 10/28; B22F 10/68; B29D 30/06; B33Y 10/00; B33Y 40/20; B33Y 80/00

(52) U.S. Cl. CPC B22F 10/28; B22F 10/68; B29D 30/0606; B33Y 10/00; B33Y 40/20; B33Y 80/00; B22F 2998/10; B29D 2030/0616; B29D 2030/0617

(57) ABSTRACT

A process for manufacturing a molding element of a curing mold, the molding element being manufactured by an additive manufacturing process, the molding element comprising a molding inner surface and an outer surface on the opposite side from the molding inner surface, and the molding element comprising at least one vent through which air can pass between the molding inner surface and the outer surface of the molding element, comprises the following steps: (a) additively manufacturing the molding element and the vent at the same time, the vent being manufactured with at least one dimension less than its final value, and (b) cleaning and enlarging the vent using a process of removal of material by chemical attack effected by immersing the molding element in a solely chemical bath so as to bring the vent to its final dimensions and to reduce the surface roughness of the vent.

### TECHNICAL FIELD

The present invention relates to the manufacture of vents in a curing mould, and more particularly in a moulding element of a tyre curing mould.

Tyre denotes a casing, notably composed of various rubber compounds and reinforcing elements, which is mounted on a rim and filled with air or a particular gas in order to form a wheel with this rim. Tyre also denotes a casing, notably composed of various rubber compounds and reinforcing elements, which is mounted on a rim without being filled with air or a particular gas in order to form a wheel with this rim.

The presence of vents in a curing mould is necessary to evacuate the air which can be trapped between the object to be moulded and the curing mould when the mould is being closed and which can prevent the material of the object to be moulded conforming to the moulding surfaces of the curing mould. Notably, the vents are necessary in partitioned regions of the mould from which the air cannot be naturally evacuated, as can be the case at the interface between two moulding elements that are movable relative to one another.

In the case of a tyre curing mould, the moulding elements of a curing mould generally comprise numerous venting slots. For example, a tyre curing mould may comprise several thousand slots.

### PRIOR ART

Patent EP3130439 proposes manufacturing a moulding element of a tyre curing mould directly with its venting slots. To this end, the moulding element is manufactured by a process of additive manufacturing by powder bed deposition and selective melting.

Patent EP3130439 also provides the manufacture of vents that take the form of slots with a width of between 0 and 0.5 mm in order to limit the penetration of the rubber compound used to fabricate the tyre into the vents. Specifically, by penetrating into the vents, the rubber compound creates flash on the outer surface of the tyre and, according to patent EP3130439, excessive flash reduces the aesthetic appeal of the tyre and also its performance in terms of road handling and its resistance to wear.

According to a drawback of the manufacturing process described in the patent EP3130439, the powder located inside a vent sometimes undergoes sintering, notably when the walls of the vent are very close to one another and for example spaced from one another by less than 0.5 mm. This sintering of the powder in the vents on the one hand results in an uneven width of the vents, which do not provide the desired flow rates of air, and on the other hand results in a considerable roughness of the walls of the vents, which promotes the retention of the rubber compound in the vents and thus blocking of the vents after only a few use cycles of the mould.

### SUMMARY OF THE INVENTION

The aim of the present invention is to overcome the drawbacks of the prior art that has just been described.

To this end, the invention relates to a process for manufacturing a moulding element of a curing mould, said moulding element being manufactured by a process of additive manufacture by powder layer deposition and selective consolidation of the layers of powder, the moulding element comprising a moulding inner surface and an outer surface on the opposite side from the moulding inner surface, and the moulding element comprising at least one vent through which air can pass between the moulding inner surface and the outer surface of the moulding element.

According to the invention, the manufacturing process comprises the following steps:
a) additively manufacturing the moulding element and the vent at the same time, the vent being manufactured with at least one dimension less than its final value, and
b) cleaning and enlarging the vent using a process of removal of material by chemical attack effected by immersing the moulding element in a chemical bath so as to bring the vent to its final dimensions and to reduce the surface roughness of the vent.

By removing material from the walls of the vents of a moulding element, the cleaning by a chemical bath makes it possible to make the width of the vents more even and thus to ensure the desired flow rates of air. The decrease in the roughness of the walls of the vents that is brought about via the cleaning by a chemical bath reduces the ability of the moulded material to be retained in the vents and thus makes it easier to clean these vents after several use cycles of the curing mould.

Advantageously, the cleaning by a chemical bath also makes it possible to evacuate the sintered powder that may be present inside the vents after the moulding element has been additively manufactured.

To promote the removal of material in the vents rather than on the inner and outer surfaces of the moulding element, the invention preferably provides that the removal of material by chemical attack in step b) is effected by immersing the moulding element in a solely chemical bath.

Advantageously, but not necessarily, the invention may also provide that:
when the vent takes the form of a slot, the slot is manufactured with a width less than its final width during step a), wherein the width of the slot is increased during step b),
the slot is manufactured with a width of between 10 and 50 μm during step a), wherein the width of the slot is increased to a value of between 20 and 70 μm during step b),
the vent has a depth of between 0.5 and 3 millimetres, preferably of between 1 and 2 millimetres,
the process of removal of material by chemical attack in step b) makes it possible to remove from a few micrometres to 30 micrometres of material from a wall of a vent,
when step b) is being carried out, the one or more rough walls of a vent are eroded more than the other, less rough parts of the moulding element,
the moulding element is manufactured from a metal alloy such as a steel of the maraging type,
the moulding element and the vent are manufactured by a process of additive manufacture by powder layer deposition and selective melting of the layers of powder,
the walls of the vent are additively manufactured in each layer of powder using a contour strategy consisting in consolidating said walls continuously all around the vent by following a closed contour or multiple closed and juxtaposed contours,
the vent leads into a clearance made in the outer surface of the moulding element, the clearance allowing more air to pass through than the vent does,
the clearance extends over the entire length of the vent,
the walls of the clearance are inclined towards the vent,
the curing mould is a tyre curing mould.

### DETAILED DESCRIPTION

Further features and advantages of the invention will become apparent from the following description. This description, given by way of non-limiting example, refers to the appended drawings, in which:

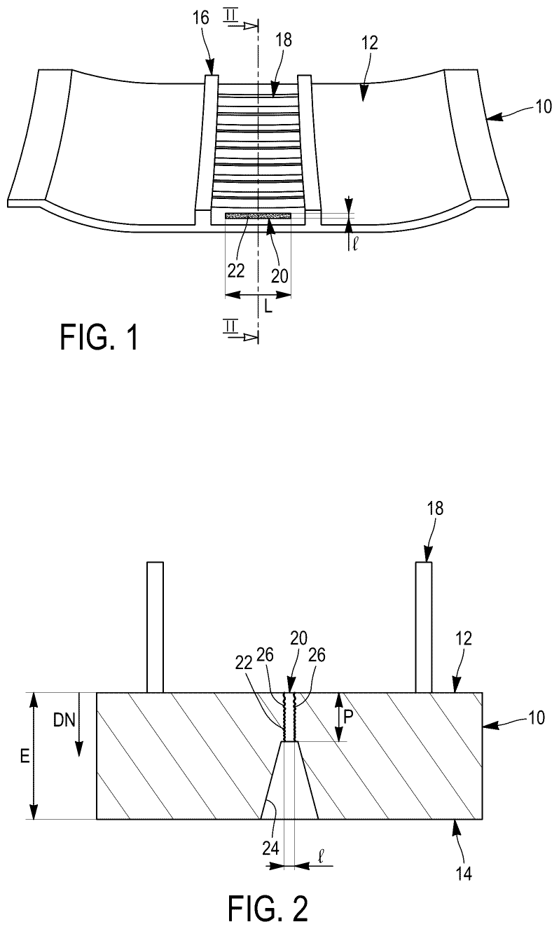

FIG. 1 schematically shows a perspective view of a moulding element of a curing mould with a vent manufactured at the same time as this moulding element,

FIG. 2 schematically shows a sectional view in a transverse median plane of a moulding element of a curing mould with a vent manufactured at the same time as this moulding element,

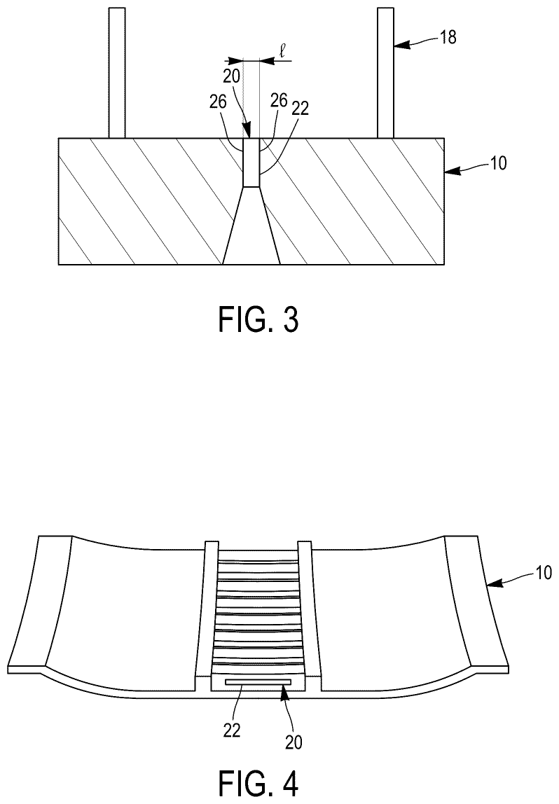

FIG. 3 schematically shows a sectional view in a transverse median plane of a moulding element of a curing mould with a vent manufactured at the same time as this moulding element and cleaned using a chemical bath in accordance with the invention,

FIG. 4 schematically shows a perspective view of a moulding element of a curing mould with a vent manufactured at the same time as this moulding element and cleaned using a chemical bath in accordance with the invention.

The invention relates to the manufacture of a moulding element of a curing mould such as a tyre curing mould.

In order to manufacture a tyre, in a first step a green tyre is assembled from semi-finished products taking the form of strips of rubber compounds, which are reinforced or not reinforced, and non-rubber components, such as metal bead wires. Then, this green tyre is placed in a curing mould in order to undergo a cycle of curing and moulding under pressure, which will give the tyre its final shape. Notably, it is during this step of curing and moulding under pressure that the patterns present on the tread of the tyre are created. The aim of the curing is also to ensure cohesion between the various components of the tyre, notably via vulcanization of the rubber compounds.

FIGS. 1 to 4 show a moulding element 10 which could be used in a tyre curing mould to shape the tread of this tyre. If this curing mould is a segmented mould, a moulding element 10 is mounted on a support belonging to a segment of this curing mould. In a segmented mould, the segments are movable relative to one another. In addition, each segment is movable between an open position used to introduce the green tyre or the object to be moulded into the curing mould and to extract the tyre after curing or the object that has just been moulded, and a closed position used for the curing and moulding under pressure of the green tyre or for the moulding of the object to be moulded.

As illustrated in FIGS. 1 and 2, the moulding element 10 comprises a moulding inner surface 12 and an outer surface 14 on the opposite side from the moulding inner surface. The outer surface 14 of the moulding element 10 is, for example, intended to be in contact with another part of the curing mould, such as a support belonging to a segment of the curing mould.

For example, the moulding inner surface 12 comprises longitudinal walls 16 intended to create longitudinal grooves in the tread of the tyre or in the object to be moulded, and transverse sipe blades 18 crossing the longitudinal walls 16 and intended to create transverse sipes in the tread of the tyre or in the object to be moulded.

In order to make it possible to evacuate air that might be trapped between the moulding inner surface 12 and the green tyre or the object to be moulded, and particularly in a partitioned region like that located between two longitudinal walls 16 and two transverse sipe blades 18, the moulding element 10 comprises at least one vent 20 through which air can pass between the moulding inner surface 12 and the outer surface 14 of the moulding element.

As shown in FIG. 2, a vent 20 is an orifice passing all the way through a moulding element 10. A vent preferably extends in a direction DN normal to the moulding inner surface 12. A vent may take various forms. In a preferred embodiment, a vent 20 takes the form of a slot 22. The opening created by the slot 22 in the moulding inner surface 12 preferably has a shape, notably rectangular or oblong shape, which is longer than it is wide. The opening created by the slot 22 in the moulding inner surface 12 may extend along a rectilinear line in the moulding inner surface 12, or along a curved line in the moulding inner surface 12, for example so as to follow the curvature of a curved transverse sipe blade 18.

In a preferred embodiment of a moulding element 10, a vent 20 has a depth P of between 0.5 and 3 millimetres, and preferably of between 1 and 2 millimetres. The depth P of a vent 20 is measured in the normal direction DN in which this vent 20 extends from the moulding inner surface 12. The depth P of a vent is limited to reduce the time spent on manufacturing this vent and to make it easier to clean this vent after one or more use cycles of the mould.

In order to limit the depth P of a vent, the vent 20 preferably leads into a clearance 24 made in the outer surface 14 of the moulding element. A clearance 24 allows more air to pass through than the vent 20 does. A clearance 24 does not lead into the moulding inner surface 12. A clearance extends only over some of the thickness E of a moulding element 10, the thickness E being the distance separating the moulding inner surface 12 from the outer surface 14. The depth P of a vent must be sufficient to avoid the moulded material flowing out of the vent and accumulating in the clearance 24.

According to the invention, the process for manufacturing a moulding element 10 comprises the following steps:
a) additively manufacturing the moulding element 10 and the vent 20 at the same time, the vent being manufactured with at least one dimension less than its final value, and
b) cleaning and enlarging the vent 20 using a process of removal of material by chemical attack effected by immersing the moulding element in a chemical bath so as to bring the vent to its final dimensions and to reduce the surface roughness of the vent.

During step a), the moulding element 10 and the vent 20 are preferably manufactured by a process of additive manufacture by powder layer deposition and selective consolidation of the layers of powder. For example, the moulding element 10 and the vent 20 are manufactured by a process of additive manufacture by powder layer deposition and selective melting of the layers of powder. The moulding element 10 is preferably manufactured from a metal alloy. For example, the moulding element 10 is manufactured from a steel of the maraging type.

Additive manufacturing by powder bed deposition and selective melting is an additive manufacturing process in which one or more objects are manufactured by the selective melting of various mutually superposed layers of additive manufacturing powder. The first layer of powder is deposited on a support such as a plate, then selectively fused using one or more sources of energy or heat along a first horizontal section of the one or more objects to be manufactured. Then, a second layer of powder is deposited on the first layer of powder that has just been fused, and this second layer of powder is selectively fused in turn, and so on, until the last layer of powder that is useful for manufacturing the last horizontal section of the one or more objects to be manufactured is reached.

In the present invention, a layer of powder is selectively melted, for example, by the movement, referred to as sweeping, of the spot of at least one laser beam over said layer of powder.

For example, the moulding element 10 and the vent 20 are additively manufactured on an additive manufacturing plate belonging to a machine for additive manufacture by powder bed deposition and selective laser melting. At the end of the additive manufacturing, the moulding element 10 is secured to the additive manufacturing plate, notably via supports which are also additively manufactured on this plate. These supports are intended to make it easier to separate the moulding element from the additive manufacturing plate and also make it possible to support parts of the moulding element that would otherwise be suspended above the plate or other parts of the moulding element.

In order to implement step b), the moulding element 10 is preferably detached from the additive manufacturing plate, and possibly also from these supports.

During step a), the manufacturing process according to the invention provides manufacturing the vent with at least one dimension less than its final value in order to make it possible to enlarge and clean the vent during the subsequent step b).

If the vent 20 takes the form of a slot 22, the slot is manufactured with a width I less than its final width during step a). Since the length L of the slot is generally much greater than its width I, the slot is for example manufactured with a length substantially equal to its final length during step a). The width I of a slot 22 corresponds to the smallest dimension of the opening created by this slot 22 in the moulding inner surface 12. Conversely, the length L of a slot 22 is the largest dimension of the opening created by this slot 22 in the moulding inner surface 12. For example, a slot is manufactured with a length L from a few millimetres to several centimetres. To promote the chemical attack on the walls 26 of the vent 20, a clearance 24 extends over the entire length of the vent, and therefore over the entire length L of a slot 22 forming a vent. To consistently concentrate the chemical attack on the walls 26 of the vent 20, and as shown in FIGS. 2 and 3, the walls of a clearance 24 are inclined towards the vent 20.

During step b), the manufacturing process according to the invention provides cleaning and enlarging the vent 20 using a process of removal of material by chemical attack effected by immersing the moulding element in a chemical bath so as to bring the vent to its final dimensions and to reduce the surface roughness of the vent. Reduce the surface roughness of the vent is understood to mean reduce the roughness of the walls 26 of the vent 20 that are located in the thickness E of the moulding element. These walls are rough, for example owing to the production of the moulding element by an additive manufacturing process, and for example owing to the heat transmitted by the walls of the vent to the powder present in the vent by conduction during the additive manufacture, and this can cause this powder to be partially sintered. In order to limit the roughness of the walls 26 of the vent and to make it easier to clean the vent by way of the chemical attack, the process according to the invention may provide that the walls 26 of the vent are additively manufactured in each layer of powder using a contour strategy consisting in consolidating said walls 26 continuously all around the vent by following a closed contour or multiple closed and juxtaposed contours.

If the vent 20 takes the form of a slot 22, and if the slot 22 is manufactured with a width I less than its final width during step a), the width I of the slot is increased during step b), as illustrated in FIGS. 2 and 3.

For example, when the vent 20 takes the form of a slot 22, the slot is manufactured with a width I of between 10 and 50 μm during step a) and the width I of the slot is increased to a value of between 20 and 70 μm during step b). As an indication, a slot 22 generally has a length L of between 5 and 50 mm.

For example, the process of removal of material by chemical attack effected in a chemical bath makes it possible to remove from a few micrometres to 30 micrometres of material from a wall 26 of a vent. In addition, the process of removal of material by chemical attack effected in a chemical bath makes it possible to reduce the roughness of a wall 26 of a vent.

The process of removal of material by chemical attack used during step b) is a surface treatment process. This process makes it possible to remove the metal from the surfaces of the moulding element ion by ion.

When step b) is being carried out, the moulding element 10 is preferably completely immersed in a chemical bath.

Advantageously, the one or more rough walls 26 of a vent are regions which, during step b), are eroded more than the other, less rough parts of the moulding element.

Ideally, the moulding element 10 is cleaned and rinsed before carrying out step b). The moulding element 10 may possibly also be stripped before carrying out step b). After step b) has been carried out, the moulding element is at least rinsed, and an after-treatment can also be performed to remove the residues of the chemical attack.

In a preferred alternative way of carrying out step b), the removal of material by chemical attack in step b) is effected by immersing the moulding element in a solely chemical bath. This solely chemical bath comprises, for example, at least one acid, and possibly at least one additive such as a surfactant, a viscosity regulator or a brightening agent. Possibly, for an optimum chemical attack, the chemical bath can be heated and temperature-controlled.

To improve the effect of the surface treatment, the chemical attack may also be combined with an electrolytic action.

Compared to a chemical and electrolytic bath, in which all the surfaces of the object are attacked, the solely chemical bath affords the advantage of further promoting the removal of material in the vents rather than on the inner and outer surfaces of the moulding element. Specifically, the roughness of the walls of the vents and the narrowness of these vents cause the chemical attack to be concentrated inside these vents. As a result, the dimensions of the moulding element, and notably of the moulding inner surface 12 of this moulding element, are not excessively modified.

Advantageously, by limiting the depth P of a vent, the duration of step b) is reduced and therefore the cost of manufacturing the moulding element 10 is reduced.

It should be noted that a moulding element 10 generally comprises a plurality of vents 20 and that the process for manufacturing a moulding element that has just been described also applies in the same way to a moulding element 10, notably a tyre curing mould, which comprises a plurality of vents 20 defining a plurality of air passages between the moulding inner surface and the outer surface of this moulding element.

The manufacturing process according to the invention is particularly suitable for manufacturing a moulding element of a tyre curing mould, and notably a segmented tyre curing mould.

1.-13. (canceled)

14. A process for manufacturing a molding element of a curing mold, the molding element being manufactured by a process of additive manufacture by powder layer deposition and selective consolidation of layers of powder, the molding element comprising a molding inner surface and an outer surface on an opposite side from the molding inner surface, and the molding element comprising at least one vent through which air can pass between the molding inner surface and the outer surface of the molding element, the manufacturing process comprising the following steps:
(a) additively manufacturing the molding element and the at least one vent at the same time, the at least one vent being manufactured with at least one dimension less than a final dimension value, and
(b) cleaning and enlarging the at least one vent using a process of removal of material by chemical attack effected by immersing the molding element in a chemical bath so as to bring the at least one vent to the final dimension value and to reduce a surface roughness of the at least one vent,
wherein the removal of material by chemical attack in step (b) is effected by immersing the molding element in a solely chemical bath.

15. The process for manufacturing a molding element of a curing mold according to claim 14, wherein, with the at least one vent taking a form of a slot, the slot is manufactured with a width less than a final width during step (a), and
wherein the width of the slot is increased during step (b).

16. The process for manufacturing a molding element of a curing mold according to claim 15, wherein the slot is manufactured with a width of between 10 and 50 μm during step (a), and
wherein the width of the slot is increased to a value of between 20 and 70 μm during step (b).

17. The process for manufacturing a molding element of a curing mold according to claim 14, wherein the at least one vent has a depth P of between 0.5 and 3 millimeters.

18. The process for manufacturing a molding element of a curing mold according to claim 14, wherein the process of removal of material by chemical attack in step (b) makes it possible to remove from a few micrometers to 30 micrometers of material from a wall of the at least one vent.

19. The process for manufacturing a molding element of a curing mold according to claim 14, wherein, when step (b) is being carried out, one or more rough walls of the at least one vent are eroded more than other, less rough parts of the molding element.

20. The process for manufacturing a molding element of a curing mold according to claim 14, wherein the molding element is manufactured from a metal alloy.

21. The process for manufacturing a molding element of a curing mold according to claim 14, wherein the molding element and the at least one vent are manufactured by a process of additive manufacture by powder layer deposition and selective melting of the layers of powder.

22. The process for manufacturing a molding element of a curing mold according to claim 21, wherein walls of the at least one vent are additively manufactured in each layer of powder using a contour strategy consisting in consolidating the walls continuously all around the at least one vent by following a closed contour or multiple closed and juxtaposed contours.

23. The process for manufacturing a molding element of a curing mold according to claim 14, wherein the at least one vent leads into a clearance made in the outer surface of the molding element, the clearance allowing more air to pass through than the at least one vent does.

24. The process for manufacturing a molding element of a curing mold according to claim 23, wherein the clearance extends over an entire length of the at least one vent.

25. The process for manufacturing a molding element of a curing mold according to claim 23, wherein walls of the clearance are inclined towards the at least one vent.

26. The process for manufacturing a molding element of a curing mold according to claim 14, wherein the curing mold is a tire curing mold.
